(19) United States
(12) Patent Application Publication
(10) Pub. No.: US 2005/0197010 A1
(43) Pub. Date: Sep. 8, 2005

(54) Safety plug

(75) Inventor: Chan Ching, Taipei Hsien (TW)

Correspondence Address: TROXELL LAW OFFICE PLLC, 5205 LEESBURG PIKE, SUITE 1404, FALLS CHURCH, VA, 22041, US

(73) Assignee: Perfect Union Co., Ltd.

(21) Appl. No.: 10/815,814

(22) Filed: Apr. 2, 2004

(30) Foreign Application Priority Data
Mar. 8, 2004 (TW) 093203465

(51) Int. Cl. H01R 4/24

(52) U.S. Cl. 439/606

(57) ABSTRACT

The present invention is to provide a safety plug for preventing a short circuit due to PVC material melting at high temperature. The features are: to plant a heat-resistant object in between two pins of the safety plug, and to form the two pins with PVC material by way of shrink; hence movement, deformation and short circuit of the two pins are avoided.

### FIELD OF THE INVENTION

The present invention relates to a safety plug, especially to the plug featuring to prevent a short circuit caused by PVC material melting at high temperature.

### BACKGROUND OF THE INVENTION

Generally, electrical products use alternating current (AC) to connect to a plug by way of an electrical cord, and two types of AC are 110 and 220 voltages. Referring to FIGS. 4 and 5, which are sectional views of plugs in prior arts, wherein a 110-V plug 1 is the most common structure and produced in a broad way. The structure comprises two pins 11, and two ends of the pins 11 connected to a copper electrical cord 12 by melting. After that, two certain periods of the pins 11 and the same length of the copper electrical cord 12 are shrunk to become an outer body 13 with PVC coating. An end of the outer body 13 is a flexible tailing wing 14 for exposing the front ends of the pins 11 to the plug 1. It is to connect the front ends with a conducting piece in an outlet for producing the plug 1 with PVC material.

As can be seen, the pins 11 are the parts which generate heat while the plug is in usage, especially a melting point where the ends of the pins connecting to the copper electrical cord 12 is a heating source and the temperature thereof is greatly raised up while in the state of overload. According to that mentioned above, the PVC material contacting with the pins 11 may then change to be harder due to the high temperature after being used for a while. It causes the relative positions between the two pins 11 to be variable or the plug may be deformed, and therefore the melted PVC material caused by the pins 11 generating high heat while in abnormal overload derives the short circuit of the two pins 11 to produce a spark and more other critical conditions to easily bring about a fire.

Depending on the conditions of the prior arts, the traditional plug 1 is certainly with the shortcomings of deformation and the short circuit caused by overheating.

Other and further features, advantages and benefits of the invention will become apparent in the following description in conjunction with the following drawings. It is to be understood that the foregoing general description and the following detailed description are exemplary and explanatory but are not to restrict the invention. The accompanying drawings are incorporated and constitute a part of this application and, together with the description, serve to explain the principles of the invention in general terms. Like numerals refer to like parts throughout the disclosure.

### SUMMARY OF THE INVENTION

The primary objective of the present invention is to provide a safety plug for preventing a short circuit due to PVC material melting at high temperature. The features are: to plant a heat-resistant object in between two pins of the safety plug, and to form the two pins with PVC material by way of shrink; hence movement, deformation and short circuit of the two pins are avoided.

### BRIEF DESCRIPTION OF THE DRAWINGS

FIG. 1 is a 3-D sketch of a safety plug of the present invention;

FIG. 2 is a perspective view of the safety plug of the present invention;

FIG. 3 is a sectional view of the safety plug of the present invention;

FIG. 4 is a perspective view of a plug in the prior arts;

FIG. 5 is a sectional view of the plug in the prior arts.

### DETAILED DESCRIPTION OF THE PREFERRED EMBODIMENTS

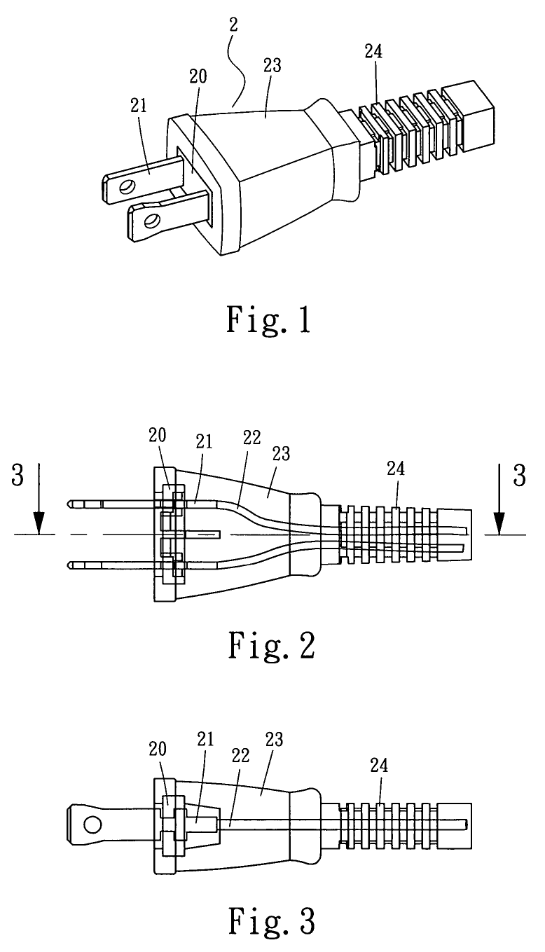

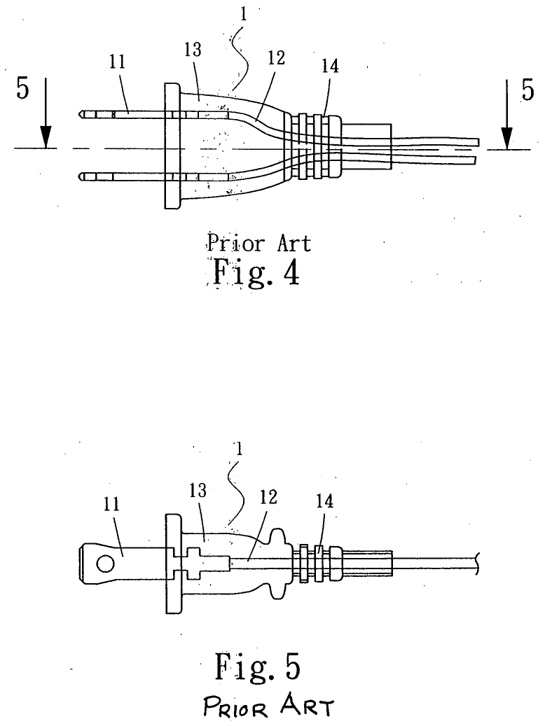

Please refer to FIGS. 1, 2 and 3, which are 3-D sketches of a safety plug of the present invention, a perspective view of the safety plug of the present invention and a sectional view of the safety plug of the present invention. A theory of the present invention is to provide a safety plug for preventing a short circuit caused by PVC material melting at high temperature. Firstly, to plant a heat-resistant and hardness-resistant object 20 as PBT (Polybutylene Terephthalate) in between two pins 21 of a safety plug 2; to form an outer body 23 for wrapping around rear sections of the two pins 21 and a certain period of an electrical cord 22 with PVC material by way of shrink, such as Molding, as well as including a flexible tailing wing 24. It is obvious that the present invention can avoid movement and deformation of the pins 21 that may cause a short circuit at high temperature.

Although the safety plug 2 is made of the material of the heat-resistant object 20 with fixing, isolating, and heat-resistance, such as PBT, which is practical; other types of material may include heat-resistant plastic material, ceramic material, etc.

The heat-resistant object 20 cannot be limited by shape and fixing ways for extending the scope of the applications thereof.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1-2. (canceled)

3. A safety plug comprising:
a) a heat-resistant and hardness object;
b) two pins, each of the two pins having a first end, a second end, and a middle portion, the heat-resistant and hardness object encasing the middle portion of each of the two pins, the first end and the second end protruding outwardly from opposing sides of the heat-resistant and hardness object;
c) an electrical cord connected to each second end and spaced apart from the heat-resistant and hardness object; and
d) an outer body covering an exterior surface of the heat-resistant and hardness object, the second end of each of the two pins, and a predetermined portion of the electrical cord,
wherein the outer body includes a flexible tailing wing spaced apart from the heat-resistant and hardness object.

4. The safety plug according to claim 3, wherein the heat-resistant and hardness object is made of Polybutylene Terephthalate.

5. The safety plug according to claim 3, wherein the heat-resistant and hardness object is made of a heat-resistant plastic material.

6. The safety plug according to claim 3, wherein the heat-resistant and hardness object is made of a ceramic material.

7. The safety plug according to claim 3, wherein the outer body is a PVC material.
